(19) United States
(12) Patent Application Publication
(10) Pub. No.: US 2004/0078323 A1
(43) Pub. Date: Apr. 22, 2004

(54) Quality control for loan processing

(75) Inventors: Mary B. Johnston, Wheaton, IL (US); Kathryn Moorshead, Lombard, IL (US); Steve Matasek, Hawthorn Woods, IL (US); Christine Foster, Bristol, IL (US)

Correspondence Address: MICHAEL BEST & FRIEDRICH LLC, 401 NORTH MICHIGAN AVENUE, SUITE 1700, CHICAGO, IL, 60611-4212, US

(73) Assignee: Household International, Inc., Prospect Heights, IL

(21) Appl. No.: 10/683,949

(22) Filed: Oct. 10, 2003

Related U.S. Application Data
(60) Provisional application No. 60/417,748, filed on Oct. 10, 2002.

(51) Int. Cl. G06F 17/60

(52) U.S. Cl. 705/38

(57) ABSTRACT

A method of quality control for loan processing employing a quality assurance shopper. The shopper is flagged in the loan processing system so that the shopper advances through the loan application and decision process without adversely affecting the individual's credit history or real property. A credit bureau is fabricated for the quality assurance shopper in the loan processing system based on a pre-determined test scenario and an existing customer's credit information. To facilitate the loan decision process, the shopper's real estate information is requested from a service company. The service company cooperates with the lender by processing quality assurance shopper flagged orders separately from other received orders. Elements of the quality assurance shopper's information are used to look up recently filled real estate information requests. Fabricated property information for the quality assurance shopper is returned to the lender. The loan is funded and the shopper evaluates the lender's business practices, customer service, and regulatory compliance.

### RELATED APPLICATIONS

This application claims the benefit of U.S. Provisional Application No. 60/417,748 filed Oct. 10, 2002.

### FIELD OF THE INVENTION

This invention pertains to a quality control method for loan processing, and more particularly to a method for evaluating the loan processing of a lending institution by employing the services of a quality assurance shopper.

### BACKGROUND OF THE INVENTION

Quality assurance shopping is well known in goods and services-based industries as a method of quality control and to verify that policies and procedures are followed to insure a consistent customer experience. Quality assurance shopping services are routinely employed by lending institutions to evaluate a front-line employee's customer service and product knowledge.

Currently available quality assurance shopping services for evaluating lending institutions audit customer service via a cold-call or cursory visit, and fall short of evaluating the complete customer experience. Quality assurance shoppers are not able to evaluate the institution's decision-making, loan rescission, or loan closing processes. Quality assurance shoppers are not able to evaluate regulatory or compliance aspects of the lending process.

When a potential borrower attempts to obtain a loan for financing or refinancing a home or other purchase, the borrower is commonly required to describe the borrower's financial condition and a description of the property. This typically involves completing one or more various forms constituting a loan application. The information entered on the forms is used to verify the customer's financial condition, and includes such information as employment income, account records, account balances, and loan balances, and to verify facts about the customer's real estate such as property description, title report, mortgage, insurance, and appraisal. The information is sometimes evaluated and processed at least in part by a computer-based system to determine the credit risk and approval status of a potential borrower.

As part of the loan application and approval process, a potential borrower expects that their credit bureau report will be ordered and inspected to determine creditworthiness. Also, a potential borrower attempting to obtain a loan for a home expects that the property will be appraised and the title report checked for encumbrances such as liens. The borrower's credit and property information are key components in the lender's decision and loan approval process, and the investigation conducted to verify this information can, itself, affect the borrower's credit history and property status. If a quality assurance shopper poses as a borrower for a mortgage, for example, and if the quality assurance shopper attempts to evaluate a lender's business practice at multiple branch offices (points of sale), the quality assurance shopper must assume the risk of potentially having their own actual credit history and property value adversely affected.

What is needed is a method of enabling a quality assurance shopper to audit a lender's loan application and approval process without affecting that quality assurance shopper's credit or property. Furthermore, it would be helpful for the method to bypass the request for that quality assurance shopper's real credit bureau report, and instead fabricate one or more credit reports so that the same quality assurance shopper can pretend to have various financial backgrounds to test the loan process. Also needed is a method for a lender to obtain fabricated real estate information about a quality assurance shopper's property from an outside real estate information vendor, such as a title company or property appraiser. This would permit lender's employee(s) and the loan process to be tested for various types of real properties, and without the costs of a real title search or appraisal.

### BRIEF SUMMARY OF THE INVENTION

The present invention provides a method of quality control for loan processing. Given the difficulties involved in a quality assurance shopper testing a lender's loan application and approval process without affecting that individual's credit or property, a process is detailed that allows for the fabrication of credit and property information for the quality assurance shopper.

An outsider such as a quality assurance shopper can typically only probe into the lender's organization and processes to a limited extent without enabling participation of the lender itself. The lender facilitates the quality assurance shopper's evaluation by entering a record for the quality assurance shopper which may include identifying information such as the shopper's name, address, and social security number into their computerized loan processing system and sets a flag on the shopper's record. The flag that is set allows for fabrication of a credit bureau report and property information, and is transparent and undetectable to nearly all of the lender's employees.

Prior to initiating a loan application, a quality assurance shopper is selected. Preferably, the shopper does not have an existing relationship with the lender. The shopper provides information to the lender that minimally includes personal information (e.g., social security number, date of birth), and residence information (e.g., address, property value, residence type). The lender enters the shopper's information in the lender's computer network to create a customer record, and flags the shopper's record so that a new credit bureau report will not be ordered. In place of ordering a real credit bureau report for the shopper, one is fabricated to supply the required criteria for the testing of a predetermined loan application scenario. The shopper is also flagged for special outside processing by an external vendor.that provides real estate information services such as a title report or property appraisal. Alternatively, if the shopper is willing to allow the lender to use the shopper's real title and appraisal for the shopper's residence, the flag for special outside processing is not set. In instances where the shopper allows the lender to use the shopper's real title and appraisal, the lender may require additional information including for example, one or more mortgage statements, a homeowner insurance statement, residence purchase price, and spouse personal and financial information.

Fabrication of a credit bureau report for the shopper entails downloading a real and existing customer's record, copying the credit information from the downloaded record, and using a record editing application. Elements or fields of the downloaded record are modified to make the record specific to the desired characteristics of the quality assurance shopper and test scenario. The newly fabricated credit bureau record for the shopper is saved to the company's customer database without affecting the shopper's actual credit history or credit score.

The quality assurance shopper applies for a loan product through a specific lender source channel. The source channel is the way that an applicant or quality assurance shopper contacts the lender. A lender may be contacted in any number of ways including the Internet, a phone call, or a visit to the lender's branch office. The shopper's information is taken and processed through the source channel by the lender, and the fabricated credit information is returned. Real estate information on the shopper's property is requested from an outside vendor.

The outside vendor electronically receives the flagged order requesting information on the quality assurance shopper's property, and moves it to a queue for special processing of flagged orders by a group separate from the outside vendor's group that processes real and existing unflagged orders. By cross-referencing the shopper's information from the flagged order to the vendor's recently processed orders, the vendor is able to look up and pull real and existing customer real estate information that is a “match” to the information supplied by the shopper. A matching order is one in which the real and existing loan applicant has similar demographics as the shopper. The matching order is copied and the copy is modified as required for the shopper in the vendor's computer network. The vendor electronically transmits comments and information back to the lender.

All pertinent information is evaluated and a decision is made by the lender on the quality assurance shopper's loan application with additional supporting documents having been provided by the lender's loan quality group. The shopper carries out a predetermined scenario that tests the lender's employee's customer service, knowledge, and adherence to company policies and regulatory compliance.

### BRIEF DESCRIPTION OF THE DRAWINGS

FIG. 1 is a flow chart of the overall method for the invention;

FIG. 2 is a flow chart illustrating the fabrication of a pre-determined applicant's credit bureau;

FIG. 3 is a flow chart illustrating the overall process of ordering and receiving an applicant's real estate information from an outside service company;

FIG. 4 is a more detailed flow chart illustrating an outside service company's order fulfillment process for a pre-determined applicant;

FIG. 5 is a screen duplication of a sample Graphical User Interface for a loan processing application showing applicant information and further illustrating the ordering of an appraisal product from an outside service company;

FIG. 6 is the sample Graphical User Interface of FIG. 5 further illustrating additional appraisal products from an outside service company;

FIG. 7 is the sample Graphical User Interface of FIG. 5 further illustrating additional appraisal products from an outside service company;

FIG. 8 is a screen duplication of a sample Graphical User Interface for a loan processing application further illustrating the ordering of an title product from an outside service company; and

FIG. 9 is a screen duplication of a sample Graphical User Interface for a loan processing application illustrating the tracking of an order to an outside service company.

### DETAILED DESCRIPTION OF A PREFERRED EMBODIMENT

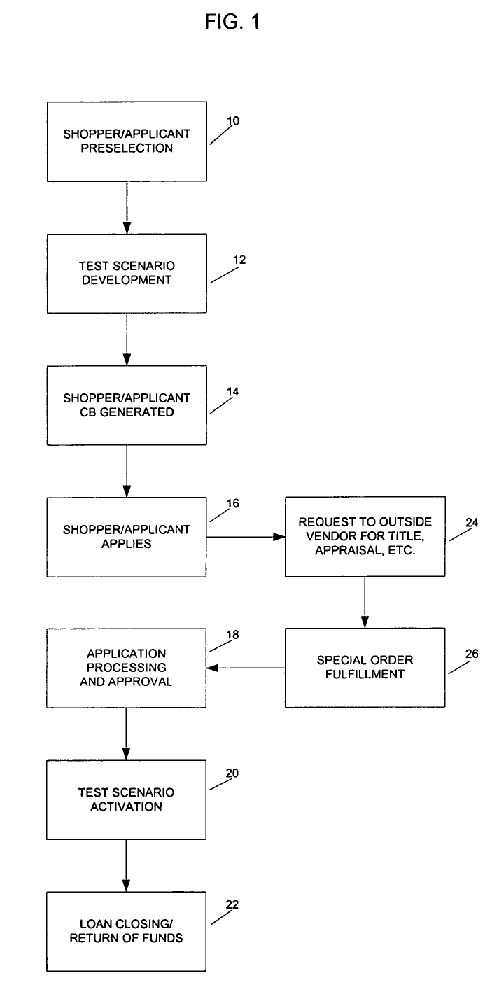

Referring to the drawings, and particularly FIG. 1, a method for auditing loan processing for quality control purposes is shown. A lender receives loan applications from customers via a source channel. The source channel is the initial method of contact for the customer and includes, but is not limited to, the Internet, a customer initiated phone call, postal service, or a customer initiated visit to a lender's point of sale. To audit the loan application, approval, and funding process, the lender pre-selects a source channel and an individual to act as a quality assurance shopper in step 10. A quality assurance shopper (or “shopper”) poses as a potential customer to verify that lender mandated procedures and government regulations are being adhered to at that point of sale location by the loan processor.

It is preferred that a quality assurance shopper be a private investigator, or minimally, someone who is experienced in objective observation and disguising the true purpose of their task. Additionally, it is preferred that the shopper have no prior relationship with the lender, and that the shopper is willing to use his or her own identity including name, Social Security number, and address in the loan application. In turn, the lender agrees that the shopper's credit rating and personal property will not be adversely affected in any way. The shopper also should be or will be bonded and must be willing to be interviewed through each step of the loan application process to provide feedback to a handler. The handler may be a lender employee in a quality assurance lending group whose duties are to supervise the shopper throughout the quality assurance process. Alternatively, the handler may be an employee of an outside vendor which provides quality assurance services, and the handler reports back to a supervising lender employee. A quality assurance shopper is typically chosen based on geographical proximity to the point of sale location. Other criteria that influence shopper selection include, but are not limited to, home ownership, workload, schedule, frequency of audits, and ability to speak a foreign language. Additionally, the lender reserves the right to disqualify any shopper if they do not fit the lender's typical customer demographics.

Frequency of audits is a particularly important factor in selecting quality assurance shoppers. For each point of sale location, there are typically a finite number of quality assurance shoppers in a given geographical area that can conveniently access that location. If a shopper were to audit one location regularly with a high frequency (e.g. on the order of every other week, or every month), the probability of that shopper being recognized by one or more lender employees increases. The continued recognition of that shopper may create suspicion and subsequently, biased treatment of the shopper may ensue. In extreme cases, continued recognition of a shopper may lead to an investigation and discovery of that shopper's true purpose. A low frequency of audits (e.g. on the order of every other month, quarterly, or annually) ensures a lower probability of recognizing that shopper. In lieu of a low frequency of audits for one location, multiple shoppers may be scheduled in an alternating fashion.

Once the quality assurance shopper is selected, a test scenario is developed at step 12. The lender develops a test scenario for the shopper, which scenario is designed to help evaluate how the lender's employees or the lender's loan process responds to various types of loan applicants, types of loans, the manner or channel by which the loan application is submitted, and other factors. The test scenario may focus on a stage or stages of the loan process, the sort of loan to be applied for, and events that may occur later in the loan process after approval by the lender. Stages of the loan process include: application, processing, decision and approval, closing, and funding. Loan products that may be applied for include: mortgage, mortgage refinance, mortgage refinance with cash out (known as non-consolidation), and home equity loans. Test scenarios such as a non-native speaking customer applying for a loan product, or a customer who has a low rate or guaranteed first mortgage, may be used to evaluate early phases of the loan process including processing, decision and approval stages. Test scenarios such as a customer wanting to take advantage of a money-back guarantee, a customer attempting a loan rescission, or a customer with a co-signer who is unavailable to sign a last minute rescission notice, may be used to evaluate late phases of the loan process, including closing and funding stages to determine regulatory compliance.

A particular test scenario is implemented at a specific lender point of sale location based on lender performance criteria. Performance criteria are lender metrics or measurements that enable the lender to categorize and rate point of sale locations as, for example, sales award winners, top insurance sales, highest number of customer complaints, and highest insurance cancellations. These criteria help determine which location should be audited or investigated, and the frequency of the audits. For example, a location categorized as sales award winner may be audited to determine if sales are due to exemplary customer service, improper strong-arm sales tactics, or predatory lending practices.

Prior to generation of a loan application for a quality assurance shopper, a credit bureau report (hereafter “credit bureau” or “bureau”) concerning the shopper's credit condition is generated along with a credit rating or credit score by the lender in step 14. The terms credit bureau and bureau are known in the art as relating to the report rather than in reference to credit reporting agencies such as Experian, Equifax, Transunion, and TRW. When a customer applies for a loan product, a lender will typically order the customer's actual credit bureau report to determine if the customer poses an unacceptable credit risk. The act of requesting or ordering a customer's credit bureau is recorded on the credit bureau and can have adverse effects to the customer. To insure that a quality assurance shopper's actual credit bureau and credit rating will not be adversely affected, a lender's normally automated credit bureau request is bypassed and fabricated credit bureau and credit rating is generated for the shopper. The fabricated credit bureau is preferably generated by a group within the lender's organization such as the quality assurance lending group mentioned above, but may alternatively be generated by other groups internal or external to the lender.

The fabrication of a credit bureau also includes internally flagging a quality assurance shopper's record so that an outside credit bureau cannot be requested via the shopper's address, name, or social security number. If for some reason a lender's employee attempts to order a new credit bureau for a quality assurance shopper, the employee will receive an error message that a duplicate request has been made, and the internally fabricated credit information for the shopper will be returned responsive to the request. Along with flagging a shopper for preventing duplicate credit bureau requests, a shopper may also be flagged for special processing relative to an outside vendor who, when requested, returns fabricated information on the shopper's property, including title report, appraisal, flood report, and other information as required. Flagging a shopper for special outside processing ensures that the shopper's property will not be encumbered. Without including this credit bureau bypass and fabrication functionality in a lender's loan processing system, along with collaboration from an outside real estate information vendor, a shopper would be unable to proceed with the loan process further than a cold-call or cursory visit to a lender's point of sale.

Alternatively, a shopper may be willing to allow the lender to use the shopper's real title and appraisal for the shopper's residence. If a shopper's real title and appraisal are to be used for a test scenario, the flag for special outside processing is not set, and the lender may require additional information from the shopper including, but not limited to, one or more mortgage statements, a homeowner insurance statement, residence purchase price and purchase date, information relative to previous mortgages, and spouse personal and financial information. The spouse may be required to play a part in the quality assurance test scenario as defined by the lender, or based on state or jurisdictional requirements.

A shopper initiates contact with the lender by applying for a loan in step 16. The shopper's information, typical of a loan application, is received at the point of sale (e.g. lender's branch office or wherever the loan is to be closed) and the application is processed for whatever loan product is being evaluated in the test scenario. As real estate information is required to complete the decision on a loan application, this information is requested from an outside vendor (e.g. a title company or real estate appraiser) in step 24 and the request is processed by the outside vendor in step 26. Since the shopper has been flagged for special processing, the outside vendor moves the shopper's order to a special processing queue and, after filling the order, returns the information to the lender in step 18. If the shopper has already provided their real title and appraisal to the lender, that real information is preferably supplied to the outside vendor by the lender's loan quality group, and the real information is transmitted, delivered, or the like to the point of sale by the vendor.

The loan application is completed and approved by the lender in step 18, and a test scenario may be activated in step 20 wherein the lender's loan quality group seeks to determine whether the customer service provided at the point of sale during late stages of the loan process, such as loan closing and funding, complies with the lender's own policies and procedures, and state and federal regulations. The application and loan are closed in step 22 and the quality assurance shopper receives the funds and returns them to the lender pursuant to their employment agreement.

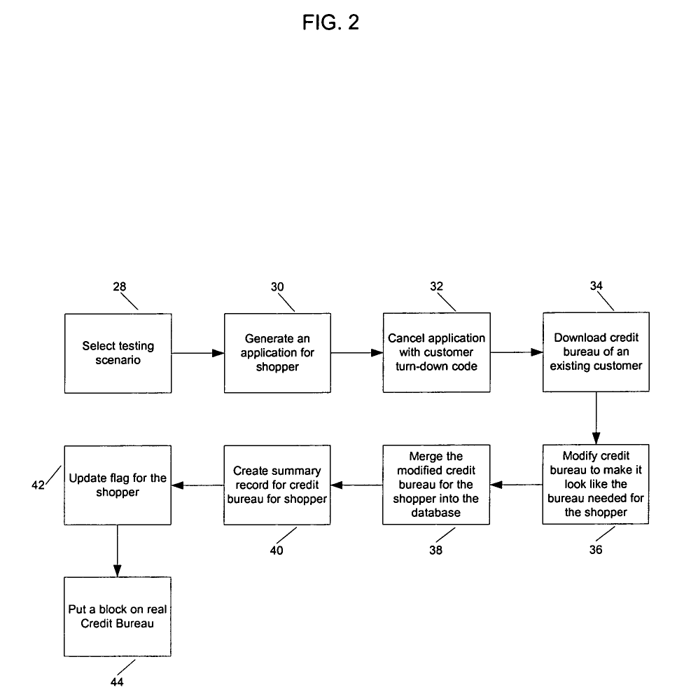

A flowchart in FIG. 2 illustrates a method of internally fabricating a quality assurance shopper's credit bureau and credit rating or score. FIG. 2 details specific steps taken in FIG. 1 block 14. The lender's loan quality group determines a scenario to be tested and sends the information to the order processing department in step 28. An application is generated for a quality assurance shopper by a lender in step 30 so that the shopper's information will be stored in the lender's customer database. The shopper's information, including name, Social Security number, financial and property information, is entered into a Graphical User Interface or front-end of a computerized customer application system, and the application is cancelled in step 32 with a cancellation code. The cancellation code may represent that the customer “turned down” or rejected the lender, and allows a shopper's partially completed application to remain in the lender's system so that a lender employee may typically follow up with the customer. The cancellation code additionally allows for the lender to later modify the shopper's application.

A real credit bureau file of a different and existing customer stored in the system is then downloaded from the customer application system in a data structure in step 34. In one test scenario, the different and existing customer has a high credit quality (i.e., credit bureau score) and is a recent customer (e.g., within the past thirty days) at a particular lender branch office where the test scenario will be implemented by the shopper. In step 36 the existing customer's downloaded credit bureau is copied and the copy is modified to protect the privacy of the existing customer, and to make it appear as if it is the quality assurance shopper's credit bureau. For example, the copy of the existing customer's downloaded credit bureau is edited with an on-line editing utility preferably residing on the lender's computer network. The bureau is edited to have a new and different customer identification number, and is further edited and adjusted to correspond to a desired test scenario. Additionally, the existing customer's downloaded credit bureau file may contain multiple credit bureaus, and therefore the downloaded file is compared to the test scenario and any credit bureaus that are unrelated to the test scenario are deleted. The fabricated credit bureau data file for the quality assurance shopper is then merged back into the lender's credit bureau database in step 38.

A summary of the credit bureau (summary record, credit score, or SWSUM) is created for the quality assurance shopper based on the real and existing customer's downloaded record. The shopper's SWSUM may be edited for the specific test scenario, or if, for example, the SWSUM shows an undesirable condition for the desired test scenario, such as more than five credit inquiries, a credit score over nine hundred, bankruptcy, or delinquency on several creditors. The edited shopper SWSUM is then merged into the summary record database in step 40. The shopper is flagged for special processing by an outside vendor in step 42 if the shopper has elected not to use their real title and appraisal, and the shopper's information is entered into a credit bureau request look-up table in step 44 so that a lender's employee receives an error message when attempting to order a new credit bureau for that particular shopper; no error message will be received if the shopper's information is entered incorrectly, instead, a true credit report will be returned which matches the incorrectly inputted information. Since error messages such as the aforementioned are not uncommon during the loan process, the receipt of an error message does not “tip off” to the lender's employee(s) the true identity or purpose of the shopper. After receiving the error message, the shopper's fabricated bureau is returned responsive to the order.

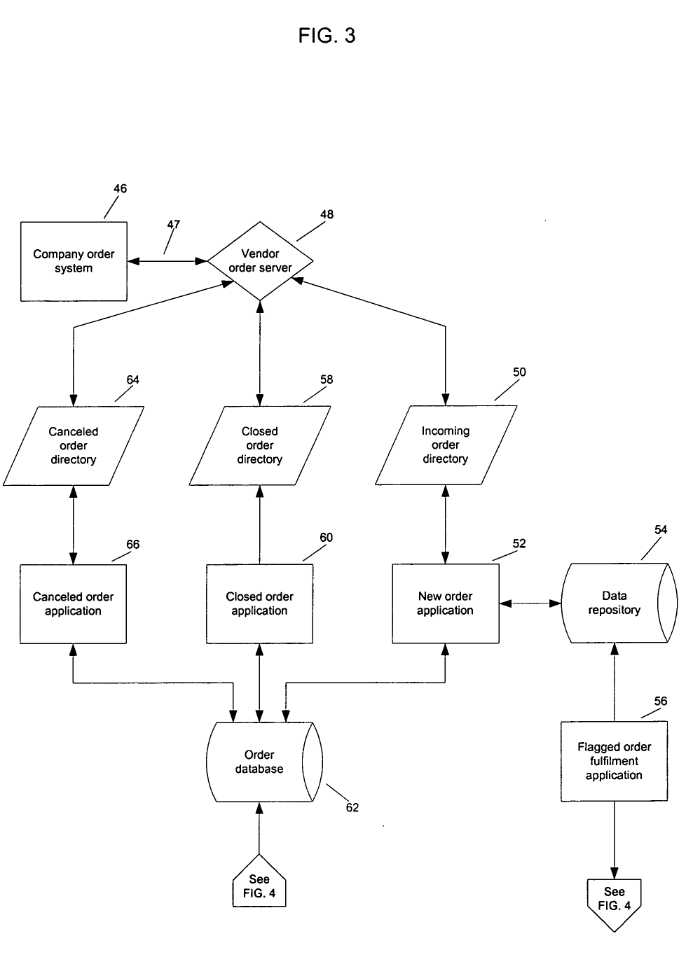

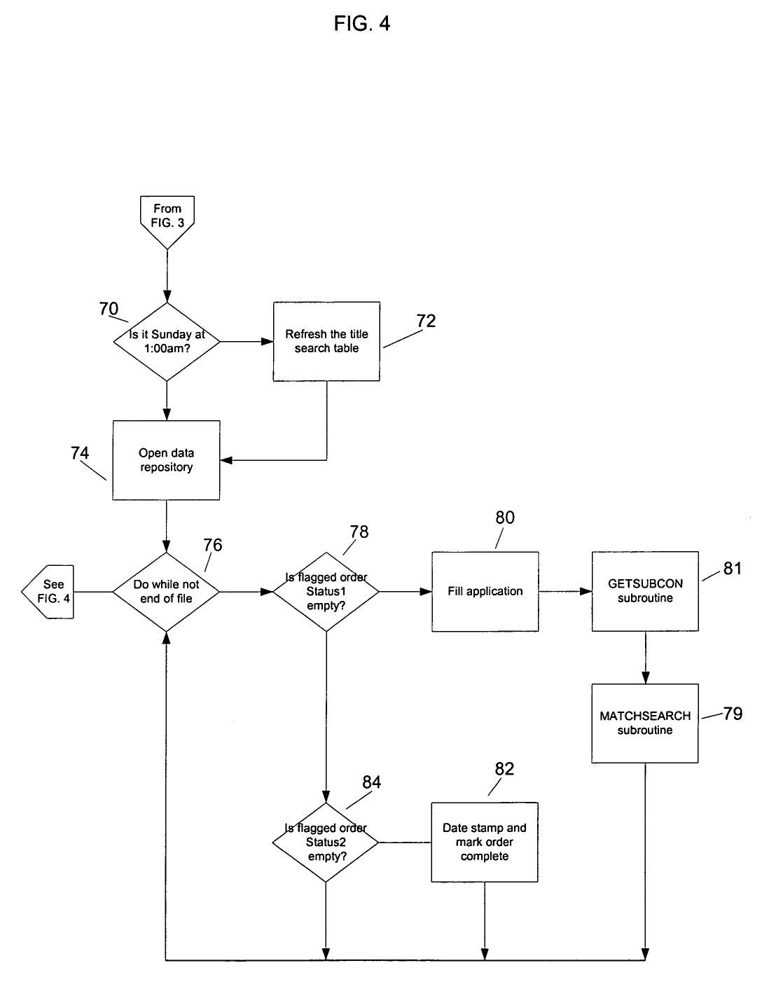

FIG. 3 is a flowchart describing the steps taken by an outside vendor to provide real estate information necessary for a quality assurance shopper's loan approval. FIG. 3 details specific steps taken in FIG. 1 blocks 24 and 26. After the shopper's loan application is initiated in the lender's application system at the point of sale, a request for the shopper's real estate information is electronically communicated to the outside vendor via a communication link 46, such as MQ series. Preferably, the request for the shopper's real estate information is initiated by the lender through selection of vendor products or services from a Graphical User Interface such as those shown in FIGS. 4-7.

The vendor, who may use a server such as an MQ series server, and hosting a Visual Basic application such as MQOrders that runs on the MQ Series server, receives the point of sale request for a shopper's real estate information in block 48, and writes the order to a data structure such as a text file on the incoming shared directory in block 50. A new order database application such as Clipper, running on a network such as Novell, continuously checks the incoming shared directory on the vendor's server for a new order data file in block 52. When the new order database application detects that a new order is flagged for special processing, the order is written to a data repository in block 54, and a receipt confirmation of the order request is returned to the lender through the communication link 46. A flagged order fulfillment database application in block 56 running on a network workstation constantly checks the data repository for the occurrence of a flagged order.

FIG. 4 is a flow diagram that continues from FIG. 3 and further details the flagged order fulfillment process of the outside vendor, specifically FIG. 3 block 56. A title-search table 72 is referenced to provide a new quality assurance shopper flagged order with real estate information including conveyances, deeds, taxes, mortgages, and legal descriptions. The title-search table is refreshed weekly in block 70, preferably during non-business hours such as on Sunday at 1:00 am EST, from the vendor's central database FIG. 3 block 62. A flagged order fulfillment database application in FIG. 3 block 56 begins a loop process in FIG. 4 blocks 78, 80, 82 and 84. Fulfillment of flagged orders is completed in two stages, and completion of each stage updates a respective status field in the flagged order (e.g. status 1 and status 2). The first stage of the two-stage loop process for filling the flagged order is completed by a fill application in block 80 which updates vendor tracking databases and calls two subroutines, GETSUBCON and MATCHSEARCH.

The GETSUBCON subroutine assigns a flagged order to a subcontractor who is preferably an appraiser. The GETSUBCON subroutine cross-references the quality assurance shopper's state and county information to a subcontractor table. After locating an appropriate subcontractor for the shopper's geography, the subcontractor's information is inserted into the flagged order, and the subcontractor is notified of the appraisal request. The subcontractor provides appraisal services for the shopper's real residence (e.g., full single family appraisal, exterior appraisal only, etc.), and returns the results to the lender. Next, the order is provided with tax, mortgage and legal description data by the MATCHSEARCH subroutine.

The MATCHSEARCH subroutine cross-references the quality assurance shopper's order information, specifically county, zip code, city and order type, with a previously prepared title report from the vendor's title-search table. After having found a match to the shopper's information, the matching title information is inserted into the flagged order. The flagged order's status 1 field is annotated as complete, and the order is evaluated at blocks 76 and 78 for order fulfillment status. If the order's status 1 is complete, status 2 is fulfilled in blocks 84 and 82.

Block 82 creates a notification message to the lender regarding the assignment of the order to a subcontractor. Block 82 also updates the quality assurance shopper's flagged order by date stamping and annotating the order as filled and transmitted to the lender. Comments on the order are returned to the lender's order originator via a communications link, and the order is removed from the vendor's system.

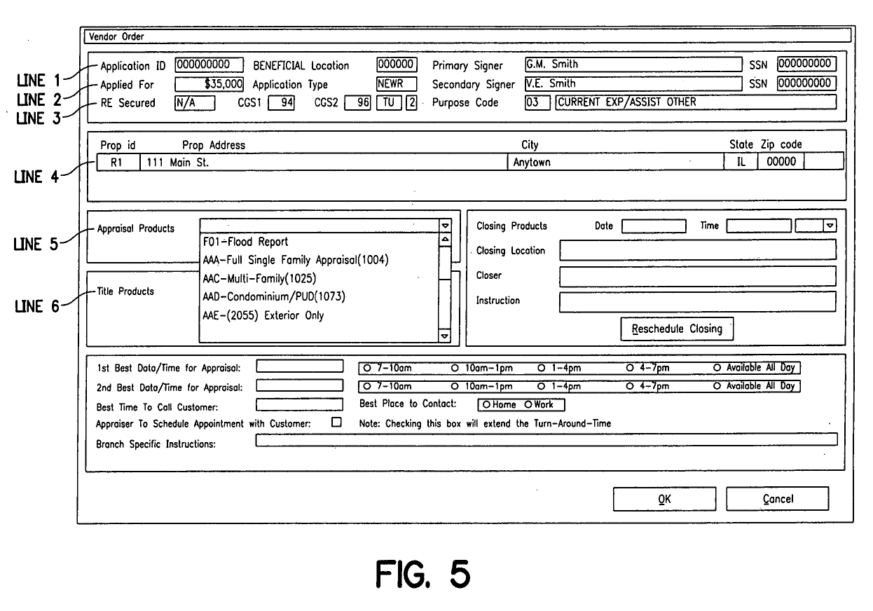

FIG. 5 is a screen duplication of a sample Graphical User Interface for a loan processing application showing applicant information. This screen is used by the lender to gather personal and property information when a potential customer contacts the lender and relates to FIG. 1 block 16. Lines 1 through 6 are of primary interest. Lines 1, 2, and 3 have applicant information including name, Social Security number, location of the office where the application was taken, loan purpose, requested dollar amount, and application type (type of financial product). Line 4 has information on the applicant's property including address, city, state, and zip code. The left hand side of line 5 is used to select various property appraisal products, as described subsequently. The left hand side of line 6 is used to select various title products, as described subsequently. A lender's representative typically enters an applicant's information into the multiple fields of Lines 1-4 to initiate the loan application. Depending on the type of loan applied for, the lender's representative will select appropriate products from the drop-down fields of Lines 5 and 6 (left hand side). Other lines and data entry fields shown in this figure and not described relate to loan closings, scheduling for an appraiser, and special instructions for the appraiser, scheduling, or other matters.

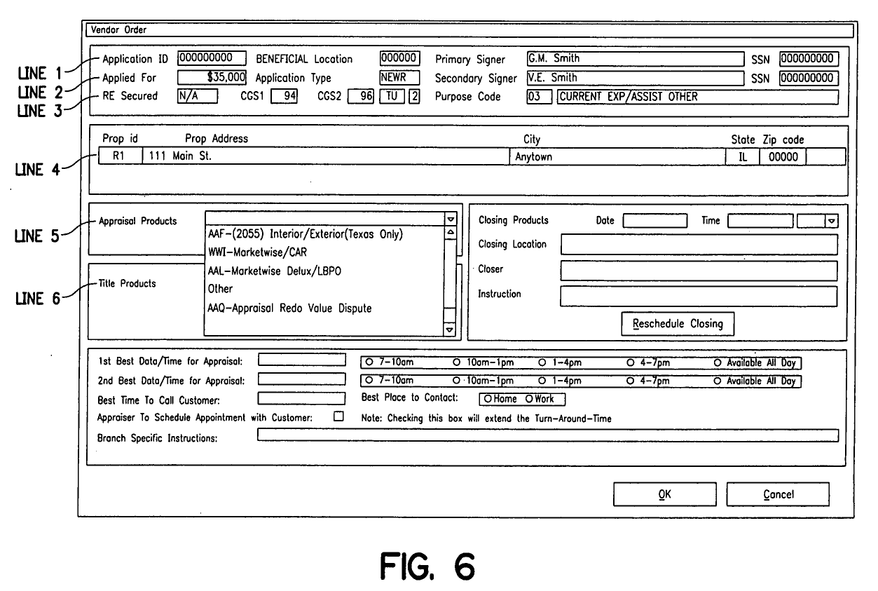

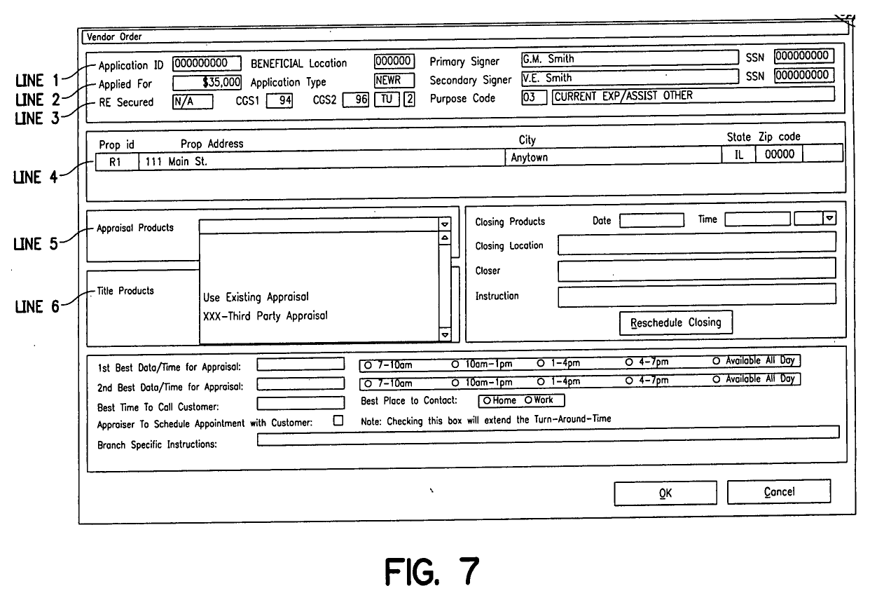

FIG. 6 is a screen duplication of a sample Graphical User Interface for a loan processing application further illustrating the appraisal product component of an applicant's information. This screen is used by the lender to order an appraisal product when a potential customer contacts the lender and relates to FIG. 1 block 16 and 24. The ordering of an appraisal product from an outside vendor is accomplished by choosing an appropriate selection in the “Appraisal Products” drop-down field of Line 5 given the type of loan being applied for. By selecting an appraisal product, the application is tagged for sending the applicant's information to an outside vendor for fulfillment. Appraisal products can be geared to a particular condition of the property securing the loan (e.g. flood report) or to the type of property (e.g. condominium). FIG. 7 further illustrates additional appraisal products that may be available in the “Appraisal Products” drop-down field of Line 5 given the type of loan being applied for.

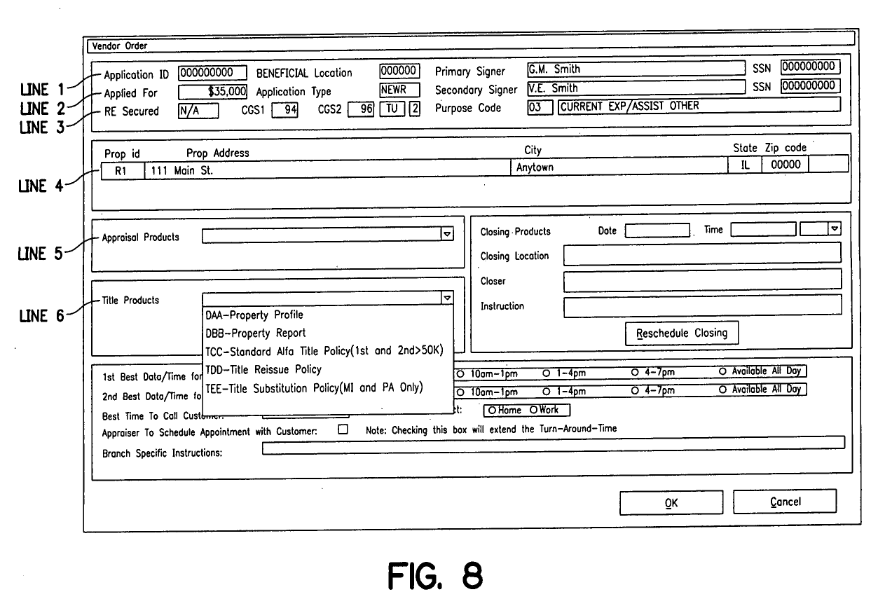

FIG. 8 is a screen duplication of a sample Graphical User Interface for a loan processing application illustrating the title product component of an applicant's information. This screen is used by the lender to order a title product when a potential customer contacts the lender and relates to FIG. 1 block 16 and 24. The ordering of a title product from an outside vendor is accomplished by choosing an appropriate selection in the “Title Products” drop-down field of Line 6. By selecting a title product, the application is tagged for sending the applicant's information to an outside vendor for fulfillment. Title products range from various types of property analyses (e.g. property profile) to types of title policies (e.g. standard Alta title policy).

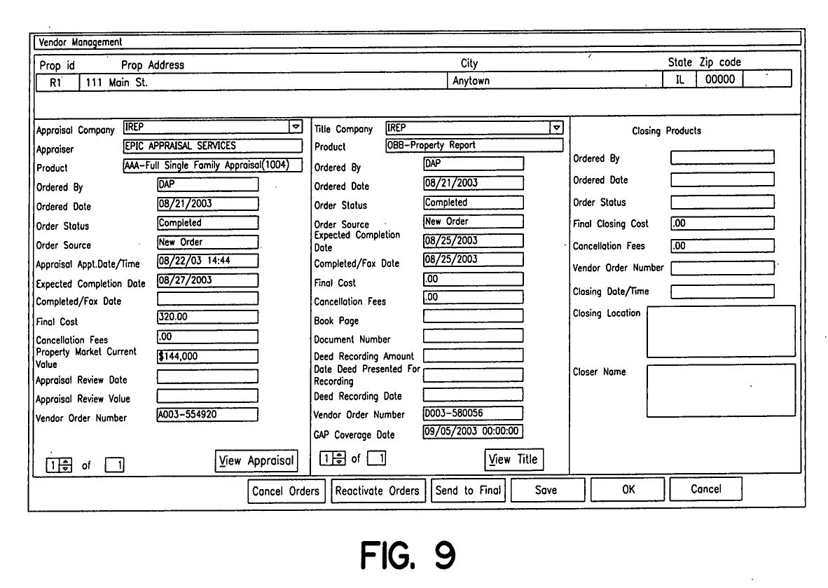

FIG. 9 is a screen duplication of a Graphical User Interface for a loan processing application illustrating the tracking of an order request sent to an outside vendor. This vendor management screen shows the dates when appraisal, title products, and closing products were ordered, and the costs incurred by the lender and by the outside vendor. This information is entered via the communication link (FIG. 3 47) as an order request is processed. Ultimately, information collected in the various fields of this screen enable the lender to make a decision on the loan application.

Preferred embodiments of this invention are described herein. Variations of those preferred embodiments may become apparent to those of ordinary skill in the art upon reading the foregoing description. Accordingly, this invention includes all modifications and equivalents of the subject matter recited in the claims appended hereto as permitted by applicable law.

What is claimed is:

1. A method for auditing a lender's loan process, which comprises the steps of:
selecting a loan applicant;
selecting a source channel for receiving a loan application;
selecting a test scenario for the selected loan applicant;
generating a fabricated credit bureau report for the selected loan applicant;
bypassing an actual credit bureau report and returning the fabricated credit bureau report; and
generating a loan application for an applicant based upon the test scenario and fabricated credit bureau report.

2. The applicant of claim 1 comprising a licensed and bonded private investigator willing to use his or her own name and identification.

3. The method of claim 1 wherein the source channel comprises the Internet, a phone call originated by an applicant, or a meeting at an office.

4. The method of claim 1 wherein the test scenario comprises an applicant-attempted loan rescission for testing the lender's response thereto.

5. The method of claim 1 wherein the test scenario comprises a loan co-signer not available to sign a rescission notice for testing the lender's response thereto.

6. The method of claim 1 wherein the testing scenario comprises a non-native speaking applicant for testing the lender's response thereto.

7. The method of claim 1 wherein the test scenario comprises an applicant wanting a money-back guarantee for testing the customer service response thereto.

8. The method of claim 1 wherein the generation of the loan applicant's credit bureau report comprises:
developing the testing scenario and entering an application for an applicant;
canceling the application with customer turn-down code;
downloading a credit bureau report of a different existing customer in a data structure;
comparing the data structure to a testing scenario and deleting one or more credit bureau reports where the data structure contains multiple credit bureau reports;
editing the data structure;
integrating the applicant's credit bureau report into the credit bureau database; and
creating a credit bureau report summary record for the applicant, and merging the summary record into the summary record file.

9. The method of claim 8 wherein the data structure comprises a formatted text spreadsheet file.

10. The method of claim 1 wherein bypassing an actual credit bureau report comprises:
entering an applicant's information in a credit bureau report lookup table;
returning an error message if a request is made to order said applicant's actual credit bureau report; and
returning a fabricated credit bureau report for said applicant.

11. The method of claim 1 further comprising the steps of:
flagging the selected applicant;
ordering the applicant's real estate information from a service vendor;
fabricating real estate information for the applicant; and
receiving fabricated real estate information for the applicant responsive to the order.

12. The method of claim 11 wherein the service vendor is a real estate appraiser or abstractor.

13. The method of claim 11 wherein flagging the applicant comprises identifying the applicant to a service vendor for fabrication of real estate information.

14. The method of claim 11 wherein ordering the applicant's real estate information comprises transmitting the applicant's information in a new order request to a service vendor's order server.

15. The method of claim 11 wherein fabricating real estate information comprises the steps of:
the service vendor checking for incoming orders and sorting each order to a corresponding incoming order directory;
checking the incoming orders for a flagged order;
placing a flagged order onto a data repository and returning an order confirmation to an order originator;
checking the data repository for a flagged order;
when a flagged order is detected, queuing said flagged order for order fulfillment.

16. The method of claim 15 wherein the data repository is checked repeatedly for the occurrence of a flagged order.

17. The method of claim 15 wherein order fulfillment comprises:
assigning the flagged order to a subcontractor;
searching the service vendor's completed orders for a matching order;
populating the flagged order with information from the matching order;
sending order fulfillment comments to the order originator; and
removing the flagged order from the data repository.

18. A method for auditing a lender's loan process, which comprises the steps of:
selecting a loan applicant;
selecting a source channel for receiving a loan application;
selecting a test scenario for the selected loan applicant;
generating a loan application for the selected loan applicant based on the test scenario;
ordering the selected loan applicant's real estate information from a service vendor; and
receiving real estate information for the selected loan applicant responsive to the order.

19. The method of claim 18 wherein the received real estate information for the selected loan applicant responsive to the order comprises applicant-provided real estate information.

20. The method of claim 18 wherein the service vendor comprises a real estate appraiser or abstractor.

21. The method of claim 18 further comprising the steps of:
flagging the selected loan applicant; and
fabricating real estate information for the selected loan applicant by the service vendor.

22. The method of claim 21 wherein flagging the selected loan applicant comprises identifying the applicant to the service vendor for fabrication of real estate information.

23. The method of claim 18 wherein ordering the selected loan applicant's real estate information comprises transmitting the selected loan applicant's information in a new order request to the service vendor's order server.

24. The method of claim 21 wherein fabricating real estate information comprises the steps of:
the service vendor checking for incoming orders and sorting each order to a corresponding incoming order directory;
checking the incoming orders for a flagged order;
placing a flagged order onto a data repository and returning an order confirmation to an order originator;
checking the data repository for a flagged order; and
queuing said flagged order for order fulfillment responsive to detection of a flagged order.

25. The method of claim 24 wherein the data repository is checked repeatedly for the occurrence of a flagged order.

26. The method of claim 24 wherein order fulfillment comprises:
assigning the flagged order to a subcontractor;
searching the service vendor's completed orders for a matching order;
populating the flagged order with information from the matching order;
sending order fulfillment comments to the order originator; and
removing the flagged order from the data repository.

27. A computer-based system for enabling a quality assurance shopper to evaluate a lender's loan process comprising;
means for displaying customer information;
first input means for fabricating a quality assurance shopper's credit bureau report;
second input means for entering loan application information from customers and quality assurance shoppers;
means for storing customer and quality assurance shoppers' credit bureau reports and loan application information;
means for identifying a quality assurance shopper for special processing relative to one or more service companies; and
means for transmitting information requests to the service companies for fulfillment and for receiving customer information responsive to said requests.

28. The computer-based system of claim 27 wherein fabricating a quality assurance shopper's credit bureau report comprises:
downloading from said storage means a credit bureau report of a different and existing customer in a data structure;
copying the different and existing customer's data structure;
editing the copy of the different and existing customer's data structure with said first input means; and
saving the quality assurance shopper's credit bureau into said storage means.

29. The computer-based system of claim 27 wherein the one or more service companies comprise a real estate appraiser or abstractor.

30. A computer system for loan processing which enables a quality assurance shopper to evaluate a lender's loan process comprising:
a data storage area comprising:
a customer database; and
a credit bureau report database;
a digital computer connected to the data storage area and comprising a first user interface for generating, entering, editing, saving, and flagging data for the quality assurance shopper; and
a second digital computer in communication with the data storage area and comprising:
a second user interface for entering loan application data for the quality assurance shopper and requesting information relative to the quality assurance shopper from one or more service companies; and
a communications link connecting the second digital computer to said one or more service companies.

31. The computer system of claim 30 wherein the first and second user interfaces comprise graphical user interfaces.

32. The computer system of claim 30 wherein the information relative to the quality assurance shopper comprises real estate information.

33. The computer system of claim 32 wherein the one or more service companies comprise a real estate appraiser or abstractor.
